(19) United States
(12) Patent Application Publication
(10) Pub. No.: US 2017/0006283 A1
(43) Pub. Date: Jan. 5, 2017

(54) COMPUTATIONALLY EFFICIENT SAMPLE ADAPTIVE OFFSET FILTERING DURING VIDEO ENCODING

(71) Applicant: Microsoft Technology Licensing, LLC, Redmond, WA (US)

(72) Inventors: You Zhou, Sammamish, WA (US); Chih-Lung Lin, Redmond, WA (US); Ming-Chieh Lee, Bellevue, WA (US)

(73) Assignee: Microsoft Technology Licensing, LLC, Redmond, WA (US)

(21) Appl. No.: 14/788,416

(22) Filed: Jun. 30, 2015

(51) Int. Cl. H04N 19/117; H04N 19/80; H04N 19/169

(52) U.S. Cl. CPC H04N 19/117; H04N 19/1883; H04N 19/80

(57) ABSTRACT

Disclosed herein are exemplary embodiments of innovations in the area of encoding pictures or portions of pictures (e.g., slices, coding tree units, or coding units) and determining whether and how certain filtering operation should be performed and flagged for performance by the decoder in the bitstream. In particular examples, various implementations for selectively performing and selectively skipping aspects of sample adaptive offset (SAO) filtering as in the H.265/HEVC standard are disclosed. Although these examples concern the H.265/HEVC standard and its SAO filter, the disclosed technology is more widely applicable to other video codecs that involve filtering operations as part of their encoding and decoding processes.

### FIELD

The disclosed technology concerns embodiments for selectively performing and selectively skipping aspects of sample adaptive offset (SAO) filtering during video encoding.

### BACKGROUND

Engineers use compression (also called source coding or source encoding) to reduce the bit rate of digital video. Compression decreases the cost of storing and transmitting video information by converting the information into a lower bit rate form. Decompression (also called decoding) reconstructs a version of the original information from the compressed form. A “codec” is an encoder/decoder system.

Over the last 25 years, various video codec standards have been adopted, including the ITU-T H.261, H.262 (MPEG-2 or ISO/IEC 13818-2), H.263, H.264 (MPEG-4 AVC or ISO/IEC 14496-10) standards, the MPEG-1 (ISO/IEC 11172-2) and MPEG-4 Visual (ISO/IEC 14496-2) standards, and the SMPTE 421M (VC-1) standard. More recently, the H.265/HEVC standard (ITU-T H.265 or ISO/IEC 23008-2) has been approved. Extensions to the H.265/HEVC standard (e.g., for scalable video coding/decoding, for coding/decoding of video with higher fidelity in terms of sample bit depth or chroma sampling rate, for screen capture content, or for multi-view coding/decoding) are currently under development. A video codec standard typically defines options for the syntax of an encoded video bitstream, detailing parameters in the bitstream when particular features are used in encoding and decoding. In many cases, a video codec standard also provides details about the decoding operations a video decoder should perform to achieve conforming results in decoding. Aside from codec standards, various proprietary codec formats define other options for the syntax of an encoded video bitstream and corresponding decoding operations.

As new video codec standards and formats have been developed, the number of coding tools available to a video encoder has steadily grown, and the number of options to evaluate during encoding for values of parameters, modes, settings, etc. has also grown. At the same time, consumers have demanded improvements in temporal resolution (e.g., frame rate), spatial resolution (e.g., frame dimensions), and quality of video that is encoded. As a result of these factors, video encoding according to current video codec standards and formats is very computationally intensive. Despite improvements in computer hardware, video encoding remains time-consuming and resource-intensive in many encoding scenarios. In particular, in many cases, evaluation of options for filtering of a picture (e.g., picture filtering performed in the inter-picture prediction loop) during video encoding can be time-consuming and resource-intensive.

### SUMMARY

In summary, the detailed description presents innovations that can reduce the computational complexity and/or computational resource usage during video encoding by selectively skipping certain evaluation stages during consideration of sample adaptive offset (SAO) filtering. In particular examples, various implementations for modifying (adjusting) encoder behavior when evaluating the application of the SAO filter of the H.265/HEVC standard are disclosed. Although these examples concern the H.265/HEVC standard and its SAO filtering process, the disclosed technology is more widely applicable to other video codecs that involve filtering operations (particularly filtering operations that involve the evaluation of multiple possible applicable filters or filtering schemes) as part of their encoding and decoding processes.

Embodiments of the disclosed technology have particular application to scenarios in which efficient, fast encoding is desirable, such as real-time encoding situations (e.g., encoding of live events, video conferencing applications, and the like). For instance, embodiments of the disclosed technology can be used when an encoder is selected for operation in a fast and/or low-latency encoding mode (e.g., for real-time (or substantially real-time) encoding).

To improve encoder speed and reduce the computational burden used during encoding, a number of different modifications to the encoder can be applied. For example, in certain example embodiments, the evaluation of the application of one or more of the SAO directional edge offset filters is skipped during encoding. In other example embodiments, the evaluation of the application of SAO band offset filtering (or SAO edge offset filtering) is skipped for at least some of the picture portions of a picture being encoded. In still other example embodiments, the evaluation of SAO filtering is skipped entirely for one or more pictures after a current picture being encoded. The determination of when, and for how many subsequent pictures, the evaluation of SAO filtering is to be skipped can be adaptive and be based at least in part on the number of units (e.g., CTUs) in the current picture encoded as having no SAO filtering applied.

The innovations can be implemented as part of a method, as part of a computing device adapted to perform the method or as part of a tangible computer-readable media storing computer-executable instructions for causing a computing device to perform the method. The various innovations can be used in combination or separately.

The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram of an example computing system in which some described embodiments can be implemented.

FIGS. 2a and 2b are diagrams of example network environments in which some described embodiments can be implemented.

FIG. 3 is a diagram of an example encoder system in conjunction with which some described embodiments can be implemented.

FIGS. 4a and 4b are diagrams illustrating an example video encoder in conjunction with which some described embodiments can be implemented.

FIG. 5(a) through 5(d) depict four gradient patterns used in edge-offset-type SAO filtering.

FIG. 6 comprises two diagrams showing how a sample value (sample value p) is altered by a positive and negative offset value for certain edge-offset categories.

FIG. 7 is a flow chart illustrating an exemplary embodiment for performing encoder-side SAO filtering according to the disclosed technology.

FIG. 8 is a flow chart illustrating an exemplary embodiment for performing encoder-side SAO filtering according to the disclosed technology.

FIG. 9 is a flow chart illustrating an exemplary embodiment for performing encoder-side SAO filtering according to the disclosed technology.

FIG. 10 is a schematic block diagram illustrating an example approach to evaluating the band offset SAO filter in accordance with one example implementation of FIG. 8.

### DETAILED DESCRIPTION

### I. General Considerations

The detailed description presents innovations in the area of encoding pictures or portions of pictures (e.g., slices, coding tree units, or coding units) and specifying whether and how certain filtering operations should be performed by the encoder. The methods can be employed alone or in combination with one another to configure the encoder such that it operates in a computationally efficient manner during the evaluation of whether (and what) SAO filtering operations are to be performed for a particular picture portion. By using embodiments of the disclosed technology, the encoder can operate with reduced computational complexity, using reduced computational resources (e.g., memory), and/or with increased speed. In particular examples, the disclosed embodiments concern the application of the sample adaptive offset (SAO) filter specified in the H.265/HEVC standard. Although these examples concern the H.265/HEVC standard and its SAO filter, the disclosed technology is more widely applicable to other video codecs that involve filtering operations (particularly filtering operations that involve the evaluation of multiple possible applicable filters or filtering schemes).

Although operations described herein are in places described as being performed by a video encoder or decoder, in many cases the operations can be performed by another type of media processing tool (e.g., image encoder or decoder).

Various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Different embodiments use one or more of the described innovations. Some of the innovations described herein address one or more of the problems noted in the background. Typically, a given technique/tool does not solve all such problems.

As used in this application and in the claims, the singular forms “a,” “an,” and “the” include the plural forms unless the context clearly dictates otherwise. Additionally, the term “includes” means “comprises.” Further, as used herein, the term “and/or” means any one item or combination of any items in the phrase. Still further, as used herein, the term “optimiz*” (including variations such as optimization and optimizing) refers to a choice among options under a given scope of decision, and does not imply that an optimized choice is the “best” or “optimum” choice for an expanded scope of decisions.

### II. Example Computing Systems

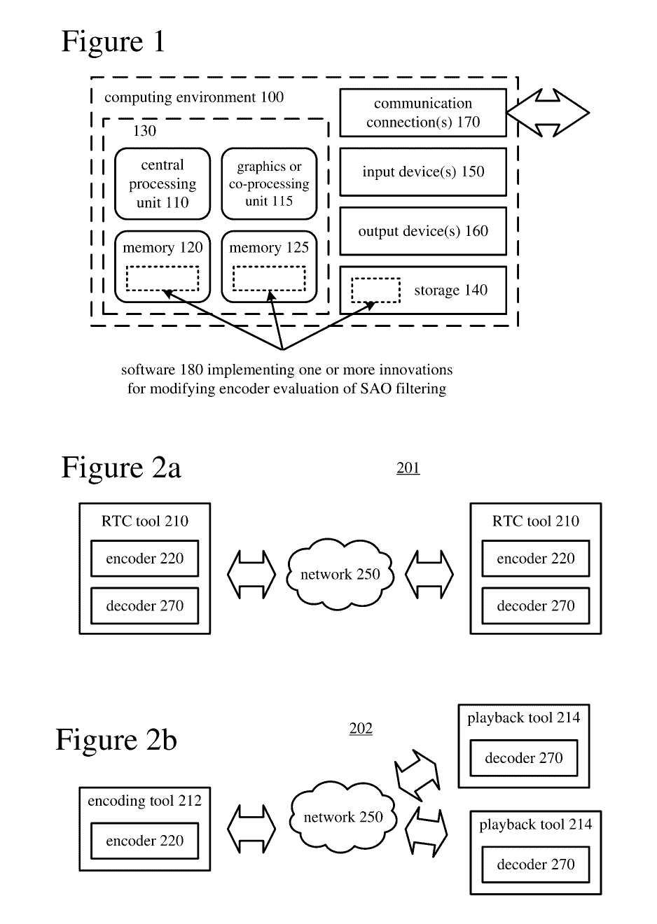

FIG. 1 illustrates a generalized example of a suitable computing system (100) in which several of the described innovations may be implemented. The computing system (100) is not intended to suggest any limitation as to scope of use or functionality, as the innovations may be implemented in diverse general-purpose or special-purpose computing systems.

With reference to FIG. 1, the computing system (100) includes one or more processing devices (110, 115) and memory (120, 125). The processing devices (110, 115) execute computer-executable instructions. A processing device can be a general-purpose central processing unit (CPU), a graphics processing unit (GPU), a processor of a system-on-a-chip (SOC), a specialized processing device implemented in an application-specific integrated circuit (ASIC) or field programmable gate array (FPGA), or any other type of processor. In a multi-processing system, multiple processing devices execute computer-executable instructions to increase processing power. For example, FIG. 1 shows a central processing unit (110) as well as a graphics processing unit or co-processing unit (115). The tangible memory (120, 125) may be one or more volatile memory devices (e.g., registers, cache, RAM), non-volatile memory devices (e.g., ROM, EEPROM, flash memory, NVRAM, etc.), or some combination of the two, accessible by the processing unit(s). The memory (120, 125) does not encompass propagating carrier waves or signals per se. The memory (120, 125) stores software (180) implementing one or more of the disclosed innovations for modifying the encoder's evaluation of filtering (e.g., SAO filtering), in the form of computer-executable instructions suitable for execution by the processing device(s).

A computing system may have additional features. For example, the computing system (100) includes storage (140), one or more input devices (150), one or more output devices (160), and one or more communication connections (170). An interconnection mechanism (not shown) such as a bus, controller, or network interconnects the components of the computing system (100). Typically, operating system software (not shown) provides an operating environment for other software executing in the computing system (100), and coordinates activities of the components of the computing system (100).

The tangible storage (140) may be one or more removable or non-removable storage devices, including magnetic disks, solid state drives, flash memories, magnetic tapes or cassettes, CD-ROMs, DVDs, or any other tangible medium which can be used to store information and which can be accessed within the computing system (100). The storage (140) does not encompass propagating carrier waves or signals per se. The storage (140) stores instructions for the software (180) implementing one or more of the disclosed innovations for modifying the encoder's evaluation of filtering (e.g., SAO filtering).

The input device(s) (150) may be a touch input device such as a keyboard, mouse, pen, trackball, a voice input device, a scanning device, or another device that provides input to the computing system (100). For video, the input device(s) (150) may be a camera, video card, TV tuner card, screen capture module, or similar device that accepts video input in analog or digital form, or a CD-ROM or CD-RW that reads video input into the computing system (100). The output device(s) (160) may be a display, printer, speaker, CD-writer, or another device that provides output from the computing system (100).

The communication connection(s) (170) enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. Computer-readable media include memory (120, 125), storage (140), and combinations of any of the above, but do not encompass propagating carrier waves or signals per se.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

The disclosed methods can also be implemented using specialized computing hardware configured to perform any of the disclosed methods. For example, the disclosed methods can be implemented by an integrated circuit (e.g., an ASIC (such as an ASIC digital signal processor (DSP), a graphics processing unit (GPU), or a programmable logic device (PLD), such as a field programmable gate array (FPGA)) specially designed or configured to implement any of the disclosed methods.

### III. Example Network Environments.

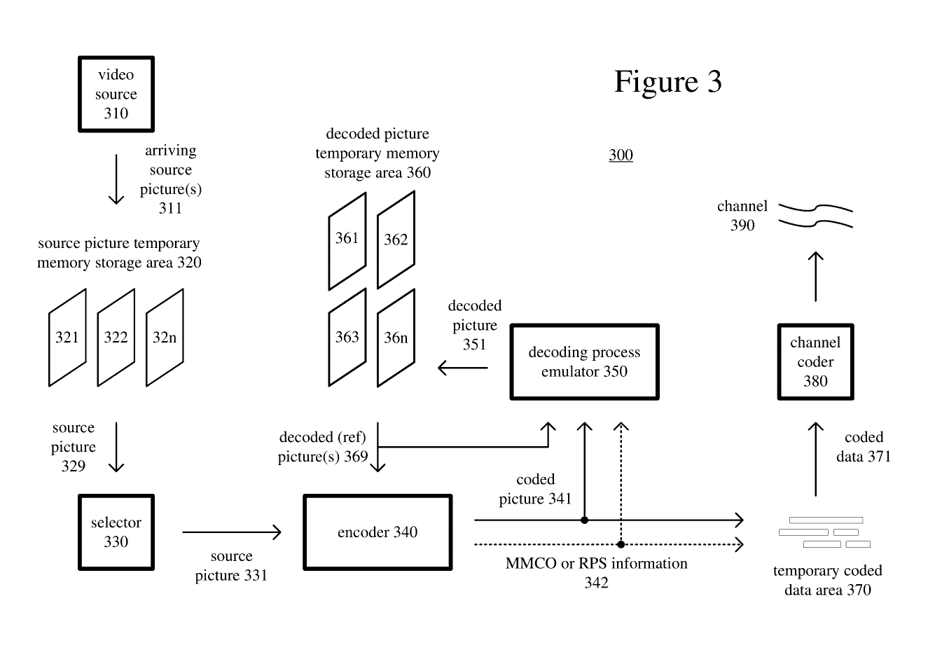

FIGS. 2a and 2b show example network environments (201, 202) that include video encoders (220) and video decoders (270). The encoders (220) and decoders (270) are connected over a network (250) using an appropriate communication protocol. The network (250) can include the Internet or another computer network.

In the network environment (201) shown in FIG. 2a, each real-time communication (RTC) tool (210) includes both an encoder (220) and a decoder (270) for bidirectional communication. A given encoder (220) can produce output compliant with a variation or extension of the H.265/HEVC standard, SMPTE 421M standard, ISO-IEC 14496-10 standard (also known as H.264 or AVC), another standard, or a proprietary format, with a corresponding decoder (270) accepting encoded data from the encoder (220). The bidirectional communication can be part of a video conference, video telephone call, or other two-party or multi-party communication scenario. Although the network environment (201) in FIG. 2a includes two real-time communication tools (210), the network environment (201) can instead include three or more real-time communication tools (210) that participate in multi-party communication.

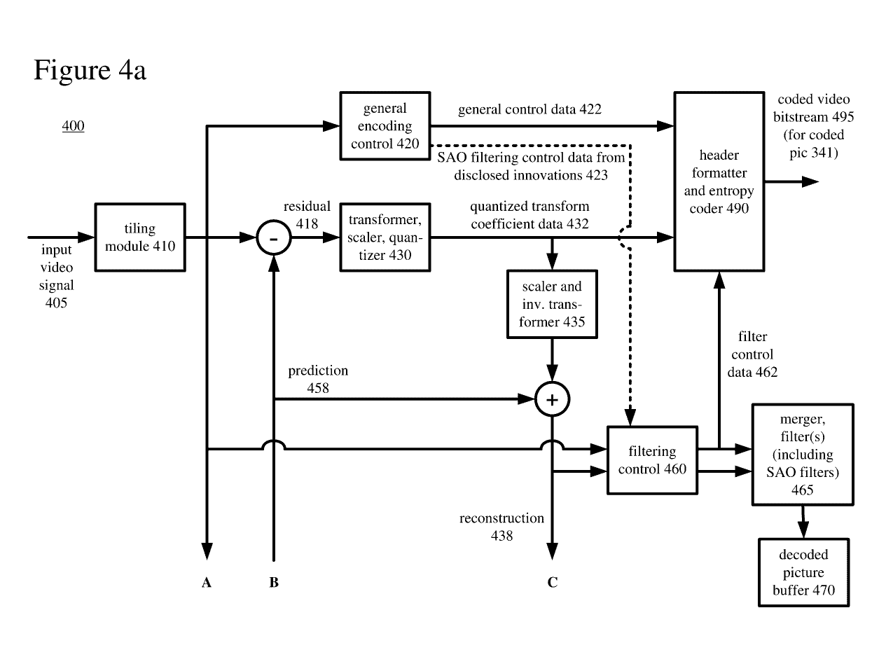

A real-time communication tool (210) manages encoding by an encoder (220). FIG. 3 shows an example encoder system (300) that can be included in the real-time communication tool (210). Alternatively, the real-time communication tool (210) uses another encoder system. A real-time communication tool (210) also manages decoding by a decoder (270).

In the network environment (202) shown in FIG. 2b, an encoding tool (212 ) includes an encoder (220) that encodes video for delivery to multiple playback tools (214), which include decoders (270). The unidirectional communication can be provided for a video surveillance system, web camera monitoring system, screen capture system, remote desktop conferencing presentation, video streaming, video downloading, video broadcasting, or other scenario in which video is encoded and sent from one location to one or more other locations. Although the network environment (202) in FIG. 2b includes two playback tools (214), the network environment (202) can include more or fewer playback tools (214). In general, a playback tool (214) communicates with the encoding tool (212) to determine a stream of video for the playback tool (214) to receive. The playback tool (214) receives the stream, buffers the received encoded data for an appropriate period, and begins decoding and playback.

FIG. 3 shows an example encoder system (300) that can be included in the encoding tool (212). Alternatively, the encoding tool (212) uses another encoder system. The encoding tool (212) can also include server-side controller logic for managing connections with one or more playback tools (214).

### IV. Example Encoder Systems.

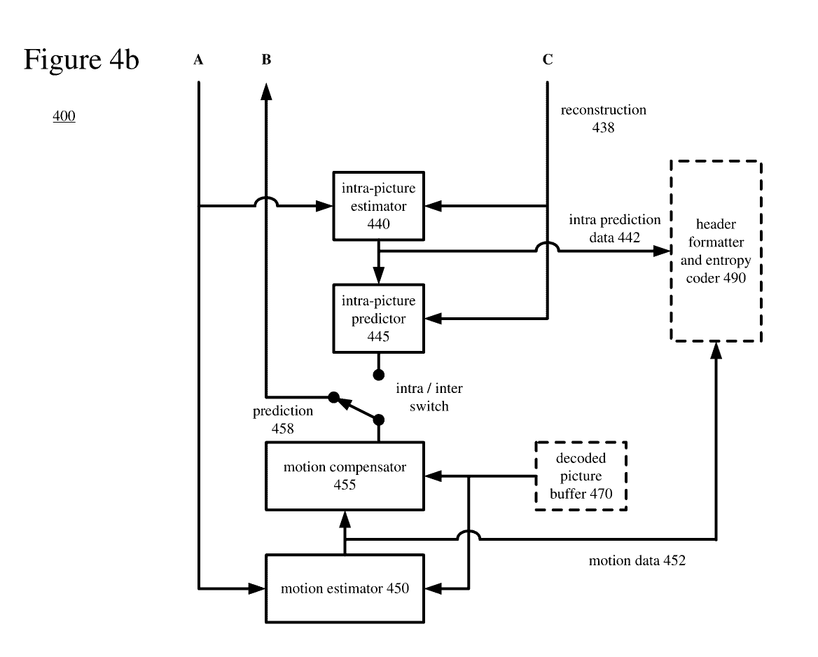

FIG. 3 shows an example video encoder system (300) in conjunction with which some described embodiments may be implemented. The video encoder system (300) includes a video encoder (340), which is further detailed in FIGS. 4a and 4b.

The video encoder system (300) can be a general-purpose encoding tool capable of operating in any of multiple encoding modes such as a low-latency “fast” encoding mode for real-time communication (and further configured to use any of the disclosed embodiments), a transcoding mode, or a higher-latency encoding mode for producing media for playback from a file or stream, or it can be a special-purpose encoding tool adapted for one such encoding mode. The video encoder system (300) can be adapted for encoding of a particular type of content. The video encoder system (300) can be implemented as part of an operating system module, as part of an application library, as part of a standalone application, or using special-purpose hardware. Overall, the video encoder system (300) receives a sequence of source video pictures (frames) (311) from a video source (310) and produces encoded data as output to a channel (390). The encoded data output to the channel can include content encoded using SAO filtering and can include one or more flags in the bitstream indicating whether and how the decoder is to apply SAO filtering. The flags can be set during encoding in accordance with the innovations described herein.

The video source (310) can be a camera, tuner card, storage media, screen capture module, or other digital video source. The video source (310) produces a sequence of video pictures at a frame rate of, for example, 30 frames per second. As used herein, the term “picture” generally refers to source, coded or reconstructed image data. For progressive-scan video, a picture is a progressive-scan video frame. For interlaced video, an interlaced video frame might be de-interlaced prior to encoding. Alternatively, two complementary interlaced video fields are encoded together as a single video frame or encoded as two separately-encoded fields. Aside from indicating a progressive-scan video frame or interlaced-scan video frame, the term “picture” can indicate a single non-paired video field, a complementary pair of video fields, a video object plane that represents a video object at a given time, or a region of interest in a larger image. The video object plane or region can be part of a larger image that includes multiple objects or regions of a scene.

An arriving source picture (311) is stored in a source picture temporary memory storage area (320) that includes multiple picture buffer storage areas (321, 322, . . . , 32n). A picture buffer (321, 322, etc.) holds one source picture in the source picture storage area (320). After one or more of the source pictures (311) have been stored in picture buffers (321, 322, etc.), a picture selector (330) selects an individual source picture (329) from the source picture storage area (320) to encode as the current picture (331). The order in which pictures are selected by the picture selector (330) for input to the video encoder (340) may differ from the order in which the pictures are produced by the video source (310), e.g., the encoding of some pictures may be delayed in order, so as to allow some later pictures to be encoded first and to thus facilitate temporally backward prediction. Before the video encoder (340), the video encoder system (300) can include a pre-processor (not shown) that performs pre-processing (e.g., filtering) of the current picture (331) before encoding. The pre-processing can include color space conversion into primary (e.g., luma) and secondary (e.g., chroma differences toward red and toward blue) components and resampling processing (e.g., to reduce the spatial resolution of chroma components) for encoding. Thus, before encoding, video may be converted to a color space such as YUV, in which sample values of a luma (Y) component represent brightness or intensity values, and sample values of chroma (U, V) components represent color-difference values. The precise definitions of the color-difference values (and conversion operations to/from YUV color space to another color space such as RGB) depend on implementation. In general, as used herein, the term YUV indicates any color space with a luma (or luminance) component and one or more chroma (or chrominance) components, including Y′UV, YIQ, Y′IQ and YDbDr as well as variations such as YCbCr and YCoCg. The chroma sample values may be sub-sampled to a lower chroma sampling rate (e.g., for a YUV 4:2:0 format or YUV 4:2:2 format), or the chroma sample values may have the same resolution as the luma sample values (e.g., for a YUV 4:4:4 format). Alternatively, video can be organized according to another format (e.g., RGB 4:4:4 format, GBR 4:4:4 format or BGR 4:4:4 format).

The video encoder (340) encodes the current picture (331) to produce a coded picture (341). As shown in FIGS. 4a and 4b, the video encoder (340) receives the current picture (331) as an input video signal (405) and produces encoded data for the coded picture (341) in a coded video bitstream (495) as output.

Generally, the video encoder (340) includes multiple encoding modules that perform encoding tasks such as partitioning into tiles, intra-picture prediction estimation and prediction, motion estimation and compensation, frequency transforms, quantization, and entropy coding. Many of the components of the video encoder (340) are used for both intra-picture coding and inter-picture coding. The exact operations performed by the video encoder (340) can vary depending on compression format and can also vary depending on encoder-optional implementation decisions. The format of the output encoded data can be Windows Media Video format, VC-1 format, MPEG-x format (e.g., MPEG-1, MPEG-2, or MPEG-4), H.26x format (e.g., H.261, H.262, H.263, H.264, H.265 (HEVC)), VPx format, a variation or extension of one of the preceding standards or formats, or another format.

As shown in FIG. 4a, the video encoder (340) can include a tiling module (410). With the tiling module (410), the video encoder (340) can partition a picture into multiple tiles of the same size or different sizes. For example, the tiling module (410) splits the picture along tile rows and tile columns that, with picture boundaries, define horizontal and vertical boundaries of tiles within the picture, where each tile is a rectangular region. Tiles are often used to provide options for parallel processing. A picture can also be organized as one or more slices, where a slice can be an entire picture or section of the picture. A slice can be decoded independently of other slices in a picture, which improves error resilience. The content of a slice or tile is further partitioned into blocks or other sets of sample values for purposes of encoding and decoding. Blocks may be further sub-divided at different stages, e.g., at the prediction, frequency transform and/or entropy encoding stages. For example, a picture can be divided into 64×64 blocks, 32×32 blocks, or 16×16 blocks, which can in turn be divided into smaller blocks of sample values for coding and decoding.

For syntax according to the H.264/AVC standard, the video encoder (340) can partition a picture into one or more slices of the same size or different sizes. The video encoder (340) splits the content of a picture (or slice) into 16×16 macroblocks. A macroblock includes luma sample values organized as four 8×8 luma blocks and corresponding chroma sample values organized as 8×8 chroma blocks. Generally, a macroblock has a prediction mode, such as inter or intra. A macroblock includes one or more prediction units (e.g., 8×8 blocks, 4×4 blocks, which may be called partitions for inter-picture prediction) for purposes of signaling of prediction information (such as prediction mode details, motion vector (MV) information, etc.) and/or prediction processing. A macroblock also has one or more residual data units for purposes of residual coding/decoding.

For syntax according to the H.265/HEVC standard, the video encoder (340) splits the content of a picture (or slice or tile) into coding tree units. A coding tree unit (CTU) includes luma sample values organized as a luma coding tree block (CTB) and corresponding chroma sample values organized as two chroma CTBs. The size of a CTU (and its CTBs) is selected by the video encoder. A luma CTB can contain, for example, 64×64, 32×32, or 16×16 luma sample values. A CTU includes one or more coding units. A coding unit (CU) has a luma coding block (CB) and two corresponding chroma CBs. For example, according to quadtree syntax, a CTU with a 64×64 luma CTB and two 64×64 chroma CTBs (YUV 4:4:4 format) can be split into four CUs, with each CU including a 32×32 luma CB and two 32×32 chroma CBs, and with each CU possibly being split further into smaller CUs according to quadtree syntax. Or, as another example, according to quadtree syntax, a CTU with a 64×64 luma CTB and two 32×32 chroma CTBs (YUV 4:2:0 format) can be split into four CUs, with each CU including a 32×32 luma CB and two 16×16 chroma CBs, and with each CU possibly being split further into smaller CUs according to quadtree syntax.

In H.265/HEVC implementations, a CU has a prediction mode such as inter or intra. A CU includes one or more prediction units for purposes of signaling of prediction information (such as prediction mode details, displacement values, etc.) and/or prediction processing. A prediction unit (PU) has a luma prediction block (PB) and two chroma PBs. According to the H.265/HEVC standard, for an intra-picture-predicted CU, the PU has the same size as the CU, unless the CU has the smallest size (e.g., 8×8). In that case, the CU can be split into smaller PUs (e.g., four 4×4 PUs if the smallest CU size is 8×8, for intra-picture prediction) or the PU can have the smallest CU size, as indicated by a syntax element for the CU. For an inter-picture-predicted CU, the CU can have one, two, or four PUs, where splitting into four PUs is allowed only if the CU has the smallest allowable size.

In H.265/HEVC implementations, a CU also has one or more transform units for purposes of residual coding/decoding, where a transform unit (TU) has a luma transform block (TB) and two chroma TBs. A CU may contain a single TU (equal in size to the CU) or multiple TUs. According to quadtree syntax, a TU can be split into four smaller TUs, which may in turn be split into smaller TUs according to quadtree syntax. The video encoder decides how to partition video into CTUs (CTBs), CUs (CBs), PUs (PBs) and TUs (TBs).

In H.265/HEVC implementations, a slice can include a single slice segment (independent slice segment) or be divided into multiple slice segments (independent slice segment and one or more dependent slice segments). A slice segment is an integer number of CTUs ordered consecutively in a tile scan, contained in a single network abstraction layer (NAL) unit. For an independent slice segment, a slice segment header includes values of syntax elements that apply for the independent slice segment. For a dependent slice segment, a truncated slice segment header includes a few values of syntax elements that apply for that dependent slice segment, and the values of the other syntax elements for the dependent slice segment are inferred from the values for the preceding independent slice segment in decoding order.

As used herein, the term “block” can indicate a macroblock, residual data unit, CTB, CB, PB or TB, or some other set of sample values, depending on context. The term “unit” can indicate a macroblock, CTU, CU, PU, TU or some other set of blocks, or it can indicate a single block, depending on context.

As shown in FIG. 4a, the video encoder (340) includes a general encoding control (420), which receives the input video signal (405) for the current picture (331) as well as feedback (not shown) from various modules of the video encoder (340). Overall, the general encoding control (420) provides control signals (not all shown) to other modules, such as the filtering control (460), tiling module (410), transformer/scaler/quantizer (430), scaler/inverse transformer (435), intra-picture prediction estimator (440), motion estimator (450) and intra/inter switch, to set and change coding parameters during encoding. The general encoding control (420) can evaluate intermediate results during encoding, typically considering bit rate costs and/or distortion costs for different options.

According to embodiments of the disclosed technology, the general encoding control (420) also decides whether to use SAO filtering and how SAO filtering processing is to be performed and generates corresponding SAO filtering control data (423). For instance, and as described more fully in Section VI below, the general encoding control (420) can modify how the filtering control (460) performs SAO filtering using SAO filtering control data (423) (e.g., by selectively skipping certain processing that evaluates potential SAO filters to apply, thereby reducing the computational effort (in terms of complexity and resource usage) and increasing the speed with which SAO filtering is performed). In many situations, and in accordance with embodiments of the disclosed technology, the general encoding control (420) (working with the filtering control (460)) can help the video encoder (340) avoid time-consuming evaluation of SAO filter options (e.g., particular edge offset filters and/or band offset filters) when such SAO filter options are unlikely to significantly improve rate-distortion performance during encoding for a particular picture or picture portion and/or when encoding speed is important (e.g., as in a real-time encoding environment).

The general encoding control (420) produces general control data (422) that indicates decisions made during encoding, so that a corresponding decoder can make consistent decisions. The general control data (422) is provided to the header formatter/entropy coder (490). The general encoding control (420) can also produce SAO filtering control data (423) that can be used by the filtering control (460) and influence the data provided by the header formatter/entropy coder (490) through filter control data (462).

With reference to FIG. 4b, if a unit of the current picture (331) is predicted using inter-picture prediction, a motion estimator (450) estimates the motion of blocks of sample values of the unit with respect to one or more reference pictures. The current picture (331) can be entirely or partially coded using inter-picture prediction. When multiple reference pictures are used, the multiple reference pictures can be from different temporal directions or the same temporal direction. The motion estimator (450) potentially evaluates candidate motion vectors (MVs) in a contextual motion mode as well as other candidate MVs. For contextual motion mode, as candidate MVs for the unit, the motion estimator (450) evaluates one or more MVs that were used in motion compensation for certain neighboring units in a local neighborhood or one or more MVs derived by rules. The candidate MVs for contextual motion mode can include MVs from spatially adjacent units, MVs from temporally adjacent units, and/or MVs derived by rules. Merge mode in the H.265/HEVC standard is an example of contextual motion mode. In some cases, a contextual motion mode can involve a competition among multiple derived MVs and selection of one of the multiple derived MVs. The motion estimator (450) can evaluate different partition patterns for motion compensation for partitions of a given unit of the current picture (331) (e.g., 2N×2N, 2N×N, N×2N, or N×N partitions for PUs of a CU in the H.265/HEVC standard).

The decoded picture buffer (470), which is an example of decoded picture temporary memory storage area (360) as shown in FIG. 3, buffers one or more reconstructed previously coded pictures for use as reference pictures. The motion estimator (450) (and/or general encoding control (420)) produces motion data (452) as side information. In particular, the motion data (452) can include information that indicates whether contextual motion mode (e.g., merge mode in the H.265/HEVC standard) is used and, if so, the candidate MV for contextual motion mode (e.g., merge mode index value in the H.265/HEVC standard). More generally, the motion data (452) can include MV data and reference picture selection data. The motion data (452) is provided to the header formatter/entropy coder (490) as well as the motion compensator (455). The motion compensator (455) applies MV(s) for a block to the reconstructed reference picture(s) from the decoded picture buffer (470). For the block, the motion compensator (455) produces a motion-compensated prediction, which is a region of sample values in the reference picture(s) that are used to generate motion-compensated prediction values for the block.

With reference to FIG. 4b, if a unit of the current picture (331) is predicted using intra-picture prediction, an intra-picture prediction estimator (440) determines how to perform intra-picture prediction for blocks of sample values of the unit. The current picture (331) can be entirely or partially coded using intra-picture prediction. Using values of a reconstruction (438) of the current picture (331), for intra spatial prediction, the intra-picture prediction estimator (440) determines how to spatially predict sample values of a block of the current picture (331) from neighboring, previously reconstructed sample values of the current picture (331), e.g., estimating extrapolation of the neighboring reconstructed sample values into the block. As side information, the intra-picture prediction estimator (440) produces intra prediction data (442), such as information indicating whether intra prediction uses spatial prediction and, if so, the IPPM used. The intra prediction data (442) is provided to the header formatter/entropy coder (490) as well as the intra-picture predictor (445). According to the intra prediction data (442), the intra-picture predictor (445) spatially predicts sample values of a block of the current picture (331) from neighboring, previously reconstructed sample values of the current picture (331), producing intra-picture prediction values for the block.

As shown in FIG. 4b, the intra/inter switch selects whether the predictions (458) for a given unit will be motion-compensated predictions or intra-picture predictions. Intra/inter switch decisions for units of the current picture (331) can be made using various criteria.

The video encoder (340) can determine whether or not to encode and transmit the differences (if any) between a block's prediction values (intra or inter) and corresponding original values. The differences (if any) between a block of the prediction (458) and a corresponding part of the original current picture (331) of the input video signal (405) provide values of the residual (418). If encoded/transmitted, the values of the residual (418) are encoded using a frequency transform (if the frequency transform is not skipped), quantization, and entropy encoding. In some cases, no residual is calculated for a unit. Instead, residual coding is skipped, and the predicted sample values are used as the reconstructed sample values. The decision about whether to skip residual coding can be made on a unit-by-unit basis (e.g., CU-by-CU basis in the H.265/HEVC standard) for some types of units (e.g., only inter-picture-coded units) or all types of units.

With reference to FIG. 4a, when values of the residual (418) are encoded, in the transformer/scaler/quantizer (430), a frequency transformer converts spatial-domain video information into frequency-domain (i.e., spectral, transform) data. For block-based video coding, the frequency transformer applies a discrete cosine transform (DCT), an integer approximation thereof, or another type of forward block transform (e.g., a discrete sine transform or an integer approximation thereof) to blocks of values of the residual (418) (or sample value data if the prediction (458) is null), producing blocks of frequency transform coefficients. The transformer/scaler/quantizer (430) can apply a transform with variable block sizes. In this case, the transformer/scaler/quantizer (430) can determine which block sizes of transforms to use for the residual values for a current block. For example, in H.265/HEVC implementations, the transformer/scaler/quantizer (430) can split a TU by quadtree decomposition into four smaller TUs, each of which may in turn be split into four smaller TUs, down to a minimum TU size. TU size can be 32×32, 16×16, 8×8, or 4×4 (referring to the size of the luma TB in the TU).

In H.265/HEVC implementations, the frequency transform can be skipped. In this case, values of the residual (418) can be quantized and entropy coded. In particular, transform skip mode may be useful when encoding screen content video, but usually is not especially useful when encoding other types of video.

With reference to FIG. 4a, in the transformer/scaler/quantizer (430), a scaler/quantizer scales and quantizes the transform coefficients. For example, the quantizer applies dead-zone scalar quantization to the frequency-domain data with a quantization step size that varies on a picture-by-picture basis, tile-by-tile basis, slice-by-slice basis, block-by-block basis, frequency-specific basis, or other basis. The quantization step size can depend on a quantization parameter (QP), whose value is set for a picture, tile, slice, and/or other portion of video. The quantized transform coefficient data (432) is provided to the header formatter/entropy coder (490). If the frequency transform is skipped, the scaler/quantizer can scale and quantize the blocks of prediction residual data (or sample value data if the prediction (458) is null), producing quantized values that are provided to the header formatter/entropy coder (490). When quantizing transform coefficients, the video encoder (340) can use rate-distortion-optimized quantization (RDOQ), which is very time-consuming, or apply simpler quantization rules.

As shown in FIGS. 4a and 4b, the header formatter/entropy coder (490) formats and/or entropy codes the general control data (422), quantized transform coefficient data (432), intra prediction data (442), motion data (452), and filter control data (462) (as influenced, for example, by the SAO filtering control date (423)). The entropy coder of the video encoder (340) compresses quantized transform coefficient values as well as certain side information (e.g., MV information, QP values, mode decisions, parameter choices). Typical entropy coding techniques include Exponential-Golomb coding, Golomb-Rice coding, arithmetic coding, differential coding, Huffman coding, run length coding, variable-length-to-variable-length (V2V) coding, variable-length-to-fixed-length (V2F) coding, Lempel-Ziv (LZ) coding, dictionary coding, and combinations of the above. The entropy coder can use different coding techniques for different kinds of information, can apply multiple techniques in combination (e.g., by applying Golomb-Rice coding followed by arithmetic coding), and can choose from among multiple code tables within a particular coding technique.

The video encoder (340) produces encoded data for the coded picture (341) in an elementary bitstream, such as the coded video bitstream (495) shown in FIG. 4a. In FIG. 4a, the header formatter/entropy coder (490) provides the encoded data in the coded video bitstream (495). The syntax of the elementary bitstream is typically defined in a codec standard or format, or extension or variation thereof. For example, the format of the coded video bitstream (495) can be a Windows Media Video format, VC-1 format, MPEG-x format (e.g., MPEG-1, MPEG-2, or MPEG-4), H.26x format (e.g., H.261, H.262, H.263, H.264, H.265 (HEVC)), VPx format, a variation or extension of one of the preceding standards or formats, or another format. After output from the video encoder (340), the elementary bitstream is typically packetized or organized in a container format, as explained below.

The encoded data in the elementary bitstream includes syntax elements organized as syntax structures. In general, a syntax element can be any element of data, and a syntax structure is zero or more syntax elements in the elementary bitstream in a specified order. In the H.264/AVC standard and H.265/HEVC standard, a NAL unit is a syntax structure that contains (1) an indication of the type of data to follow and (2) a series of zero or more bytes of the data. For example, a NAL unit can contain encoded data for a slice (coded slice). The size of the NAL unit (in bytes) is indicated outside the NAL unit. Coded slice NAL units and certain other defined types of NAL units are termed video coding layer (VCL) NAL units. An access unit is a set of one or more NAL units, in consecutive decoding order, containing the encoded data for the slice(s) of a picture, and possibly containing other associated data such as metadata.

For syntax according to the H.264/AVC standard or H.265/HEVC standard, a picture parameter set (PPS) is a syntax structure that contains syntax elements that may be associated with a picture. A PPS can be used for a single picture, or a PPS can be reused for multiple pictures in a sequence. A PPS is typically signaled separate from encoded data for a picture (e.g., one NAL unit for a PPS, and one or more other NAL units for encoded data for a picture). Within the encoded data for a picture, a syntax element indicates which PPS to use for the picture. Similarly, for syntax according to the H.264/AVC standard or H.265/HEVC standard, a sequence parameter set (SPS) is a syntax structure that contains syntax elements that may be associated with a sequence of pictures. A bitstream can include a single SPS or multiple SPSs. An SPS is typically signaled separate from other data for the sequence, and a syntax element in the other data indicates which SPS to use.

As shown in FIG. 3, the video encoder (340) also produces memory management control operation (MMCO) signals (342) or reference picture set (RPS) information. The RPS is the set of pictures that may be used for reference in motion compensation for a current picture or any subsequent picture. If the current picture (331) is not the first picture that has been encoded, when performing its encoding process, the video encoder (340) may use one or more previously encoded/decoded pictures (369) that have been stored in a decoded picture temporary memory storage area (360). Such stored decoded pictures (369) are used as reference pictures for inter-picture prediction of the content of the current picture (331). The MMCO/RPS information (342) indicates to a video decoder which reconstructed pictures may be used as reference pictures, and hence should be stored in a picture storage area.

With reference to FIG. 3, the coded picture (341) and MMCO/RPS information (342) (or information equivalent to the MMCO/RPS information (342), since the dependencies and ordering structures for pictures are already known at the video encoder (340)) are processed by a decoding process emulator (350). The decoding process emulator (350) implements some of the functionality of a video decoder, for example, decoding tasks to reconstruct reference pictures. In a manner consistent with the MMCO/RPS information (342), the decoding process emulator (350) determines whether a given coded picture (341) needs to be reconstructed and stored for use as a reference picture in inter-picture prediction of subsequent pictures to be encoded. If a coded picture (341) needs to be stored, the decoding process emulator (350) models the decoding process that would be conducted by a video decoder that receives the coded picture (341) and produces a corresponding decoded picture (351). In doing so, when the video encoder (340) has used decoded picture(s) (369) that have been stored in the decoded picture storage area (360), the decoding process emulator (350) also uses the decoded picture(s) (369) from the storage area (360) as part of the decoding process.

The decoding process emulator (350) may be implemented as part of the video encoder (340). For example, the decoding process emulator (350) includes modules and logic shown in FIGS. 4a and 4b. During reconstruction of the current picture (331), when values of the residual (418) have been encoded/signaled, reconstructed residual values are combined with the prediction (458) to produce an approximate or exact reconstruction (438) of the original content from the video signal (405) for the current picture (331). (In lossy compression, some information is lost from the video signal (405).)

To reconstruct residual values, in the scaler/inverse transformer (435), a scaler/inverse quantizer performs inverse scaling and inverse quantization on the quantized transform coefficients. When the transform stage has not been skipped, an inverse frequency transformer performs an inverse frequency transform, producing blocks of reconstructed prediction residual values or sample values. If the transform stage has been skipped, the inverse frequency transform is also skipped. In this case, the scaler/inverse quantizer can perform inverse scaling and inverse quantization on blocks of prediction residual data (or sample value data), producing reconstructed values. When residual values have been encoded/signaled, the video encoder (340) combines reconstructed residual values with values of the prediction (458) (e.g., motion-compensated prediction values, intra-picture prediction values) to form the reconstruction (438). When residual values have not been encoded/signaled, the video encoder (340) uses the values of the prediction (458) as the reconstruction (438).

For intra-picture prediction, the values of the reconstruction (438) can be fed back to the intra-picture prediction estimator (440) and intra-picture predictor (445). For inter-picture prediction, the values of the reconstruction (438) can be used for motion-compensated prediction of subsequent pictures. The values of the reconstruction (438) can be further filtered. A filtering control (460) determines how to perform deblock filtering and sample adaptive offset (SAO) filtering on values of the reconstruction (438), for the current picture (331). The filtering control (460) produces filter control data (462), which is provided to the header formatter/entropy coder (490) and merger/filter(s) (465). The filtering control (460) can be controlled, in part, by general encoding control (420) (using SAO filtering control data (423)) and perform SAO filtering using any of the innovations disclosed herein.

In the merger/filter(s) (465), the video encoder (340) merges content from different tiles into a reconstructed version of the current picture. In the merger/filter(s) (465), the video encoder (340) also selectively performs deblock filtering and SAO filtering according to the filter control data (462) and rules for filter adaptation, so as to adaptively smooth discontinuities across boundaries in the current picture (331). For example, SAO filtering can be performed in accordance with any of the disclosed embodiments for reducing the computational effort used during SAO filtering, thereby improving encoder speed as may be beneficial for certain applications (e.g., real-time or near real-time encoding).

Other filtering (such as de-ringing filtering or adaptive loop filtering (ALF); not shown) can alternatively or additionally be applied. Tile boundaries can be selectively filtered or not filtered at all, depending on settings of the video encoder (340), and the video encoder (340) may provide syntax elements within the coded bitstream to indicate whether or not such filtering was applied.

In FIGS. 4a and 4b, the decoded picture buffer (470) buffers the reconstructed current picture for use in subsequent motion-compensated prediction. More generally, as shown in FIG. 3, the decoded picture temporary memory storage area (360) includes multiple picture buffer storage areas (361, 362, . . . , 36n). In a manner consistent with the MMCO/RPS information (342), the decoding process emulator (350) manages the contents of the storage area (360) in order to identify any picture buffers (361, 362, etc.) with pictures that are no longer needed by the video encoder (340) for use as reference pictures. After modeling the decoding process, the decoding process emulator (350) stores a newly decoded picture (351) in a picture buffer (361, 362, etc.) that has been identified in this manner.

As shown in FIG. 3, the coded picture (341) and MMCO/RPS information (342) are buffered in a temporary coded data area (370). The coded data that is aggregated in the coded data area (370) contains, as part of the syntax of the elementary bitstream, encoded data for one or more pictures. The coded data that is aggregated in the coded data area (370) can also include media metadata relating to the coded video data (e.g., as one or more parameters in one or more supplemental enhancement information (SEI) messages or video usability information (VUI) messages).

The aggregated data (371) from the temporary coded data area (370) is processed by a channel encoder (380). The channel encoder (380) can packetize and/or multiplex the aggregated data for transmission or storage as a media stream (e.g., according to a media program stream or transport stream format such as ITU-T H.222.0 I ISO/IEC 13818-1 or an Internet real-time transport protocol format such as IETF RFC 3550), in which case the channel encoder (380) can add syntax elements as part of the syntax of the media transmission stream. Or, the channel encoder (380) can organize the aggregated data for storage as a file (e.g., according to a media container format such as ISO/IEC 14496-12), in which case the channel encoder (380) can add syntax elements as part of the syntax of the media storage file. Or, more generally, the channel encoder (380) can implement one or more media system multiplexing protocols or transport protocols, in which case the channel encoder (380) can add syntax elements as part of the syntax of the protocol(s). The channel encoder (380) provides output to a channel (390), which represents storage, a communications connection, or another channel for the output. The channel encoder (380) or channel (390) may also include other elements (not shown), e.g., for forward-error correction (FEC) encoding and analog signal modulation.

### V. SAO Filtering

In general, SAO filtering is designed to reduce undesirable visual artifacts, including ringing artifacts that can be compounded with large transformations. SAO filtering is also designed to reduce average sample distortions in a region by first classifying the region samples into multiple categories with a selected classifier, obtaining an offset for each category, and adding the offset to each sample of the category.

SAO filtering is performed in the merger/filter(s) (465) and modifies samples of a picture after application of a deblocking filter by applying offset values. The encoder (e.g., encoder (340)) can evaluate which (if any) of the SAO filters should be applied and produce appropriate signals in the resulting encoded bitstream to signal application of the selected SAO filter. SAO can be signaled for application on a sequence parameter set (SPS) basis, on a slice-by-slice basis within a particular SPS, or on a coding-tree-unit basis within a particular slice. The coding tree unit can be a coding tree block (CTB) for luminance values or a coding tree block for chrominance values. For instance, for a given luminance or chrominance CTB, depending on the local gradient at the sample position, certain positive or negative offset values can be applied to the sample.

According to the H.265/HEVC standard, a value of the syntax element sao_type_idx equal to 0 indicates that the SAO is not applied to the region, sao_type_idx equal to 1 signals the use of band-offset-type SAO filtering (BO), and sao_type_idx equal to 2 signals the use of edge-offset-type SAO filtering (EO). In this regard, SAO filtering for luminance values in a CTB are controlled by a first syntax element (sao_type_idx_luma), whereas SAO filtering for chrominance values in a CTB are controlled by a second syntax element (sao_type_idx_chroma).

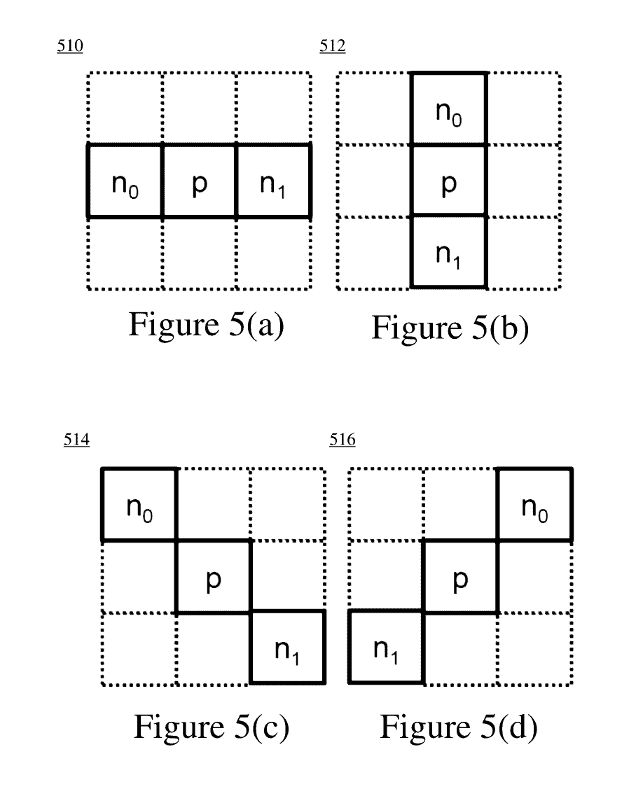

In the case of edge-offset (EO) mode SAO filtering (specified by sao_type_idx equal to 2), the syntax element sao_eo_class (which has values from 0 to 3) signals whether the horizontal, the vertical, or one of two diagonal gradients is used for EO filtering. FIGS. 5(a)-5(d) 10 depict the four gradient (or directional) patterns 510, 512, 514, 516 that are used in EO-type SAO filtering. In FIGS. 5(a)-5(d), the sample labeled “p” indicates a center sample to be considered. The samples labeled “n₀” and “n₁” specify two neighboring samples along the gradient pattern. Pattern 510 of FIG. 5(a) illustrates the horizontal 0° gradient pattern (sao_eo_class=0), pattern 512 of FIG. 5(b) illustrates the vertical 90° gradient pattern (sao_eo_class=1), pattern 514 of FIG. 5(c) illustrates the 135° diagonal pattern (sao_eo_class=2), and pattern 516 of FIG. 5(d) illustrates the 45° diagonal pattern (sao_eo_class=3).

In the edge-offset (EO) mode, once a specific sao_eo_class is chosen for a CTB, all samples in the CTB are classified into one of five EdgeIdx categories by comparing the sample value located at p with two neighboring sample values located at n₀ and n₁ as shown in Table 1. This edge index classification is done for each sample at both the encoder and the decoder, so no additional signaling for the classification is required. Specifically, when SAO filtering is determined to be performed by the encoder (e.g., according to any of the techniques disclosed) and when EO filtering selected, the classification is performed by the encoder according to the classification rules in Table 1. On the decoder side, when SAO filtering is specified to be performed for a particular sequence, slice, or CTB; and when EO filtering is specified, the classification will also be performed by the decoder according to the classification rules in Table 1. Stated differently, the edge index can be calculated by edgeIndex=2+sign(p-n₀)+sign(p-n₁), where sign(x) is 1 for ×>0, 0 for x==0, and −1 for ×<0. When edgeIdx is equal to 0, 1, or 2, edgeIdx is modified as follows: edgeIdx=(edgeIdx==2)?0: (edgeIdx+1)

TABLE 1
Sample EdgeIdx Categories in SAO Edge Classes

| EdgeIdx | Condition | Meaning |
|---|---|---|
| 0 | p = n₀ and p = n₁ or n₀ < p < n₁ or | flat area |
| | n₀ > p > n₁ | |
| 1 | p < n₀ and p < n₁ | local min (local valley) |
| 2 | p < n₀ and p = n₁ or p < n₁ and p = n₀ | edge (concave comer) |
| 3 | p > n₀ and p = n₁ or p > n₁ and p = n₀ | edge (convex corner) |
| 4 | p > n₀ and p > n₁ | local max (local peak) |

For sample categories from 1 to 4, a certain offset value is specified for each category, denoted as the edge offset, which is added to the sample value. Thus, a total of four edge offsets are estimated by the encoder and transmitted to the decoder for each CTB for edge-offset (EO) filtering.

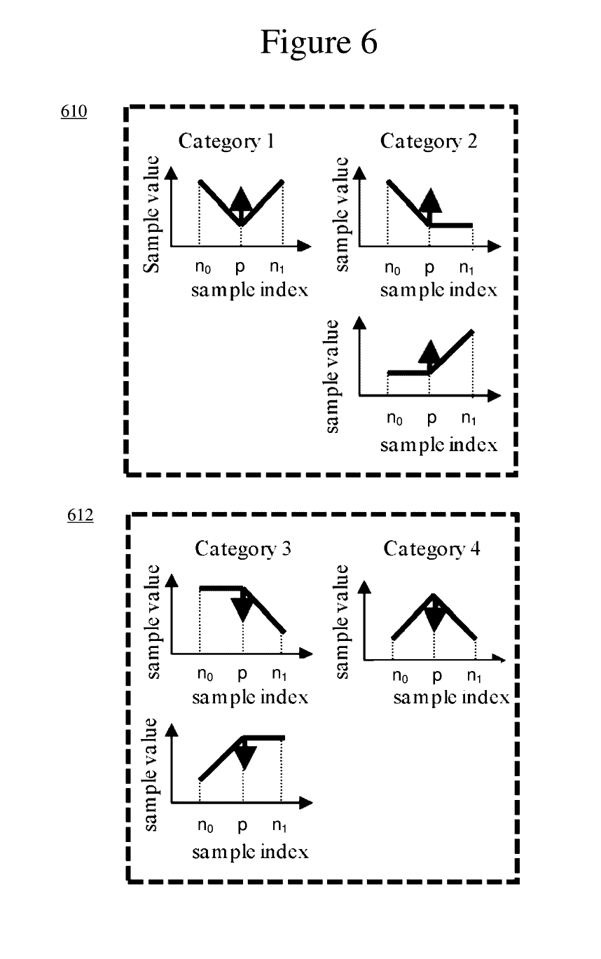

To reduce the bit overhead for transmitting the four edge offsets which are originally signed values, HEVC/H.265 specifies positive offset values for the categories 1 and 2 and negative offset values for the categories 3 and 4, since these cover most relevant cases. FIG. 6 comprises diagram 610 showing how a sample value (sample value p) is altered by a positive offset value for categories 1 and 2, and diagram 612 showing how a sample value (sample value p) is altered by a negative offset value for categories 3 and 4.

In the banding-offset (BO) mode SAO filtering (specified by sao_type_idx equal to 1), the selected offset value depends directly on the sample amplitude. The whole relevant sample amplitude range is split into 32 bands and the sample values belonging to four consecutive bands are modified by adding the values denoted as band offsets. The main reason of the use of four consecutive bands lies in the fact that in flat areas where banding artifacts could appear, most sample amplitudes in a CTB tend to be concentrated in only few bands. In addition, this design choice is unified with the edge offset types which also use four offset values. For the banding offset (BO), the pixels are firstly classified by the pixel value. The band index is calculated by bandIndex=p>>(bitdepth−5), where p is the pixel value and the bitdepth is the bit depth of the pixel. For example, for an 8-bit pixel, a pixel value in [0, 7] has index 0, a pixel value in [8, 15] has index 1, etc. In BO, the pixels belonging to specified band indexes are modified by adding a signaled offset.

For edge offset (EO) filtering, the best gradient (or directional) pattern and four corresponding offsets to be used are evaluated and determined by the encoder. For band offset (BO) filtering, the starting position of the bands is also evaluate and determined by the encoder. The parameters can be explicitly encoded or can be inherited from the left CTB or above CTB (in the latter case signaled by a special merge flag). Furthermore, the encoder can evaluate the application of either SAO filtering schemes (edge offset filtering or band offset filtering), and select which one to apply or select to apply neither of the schemes for a particular CTB. When one of the SAO filters is selected by the encoder, its selection and the appropriate control values as explained above can be signaled in the bitstream for application by the decoder. Although SAO filtering is typically discussed herein as being applied on a CTB-by-CTB basis, it can be applied on other picture-portion (or unit) bases as well.

In summary, SAO is a non-linear filtering operation that allows additional minimization of the reconstruction error in a way that cannot be achieved by linear filters. SAO filtering is specifically configured to enhance edge sharpness. In addition, it has been found that SAO is very efficient to suppress pseudo-edges, referred to as “banding artifacts”, as well as “ringing artifacts” coming from the quantization errors of high-frequency components in the transform domain.

### VI. Exemplary Methods for Computationally Efficient Encoder-Side SAO Filtering

Disclosed below are example methods that can be performed by an encoder to determine whether and how to perform SAO filtering during the encoding of a picture. The methods can be used, for example, to modify the encoder-side processing that evaluates potential SAO filters or filtering schemes (e.g., edge offset filtering and/or band offset filtering) to apply in order to reduce the computational effort (e.g., to reduce computational complexity and computational resource usage) and increase the speed with which SAO filtering is performed. In particular implementations, the methods are performed at least in part by the general encoding control (420), which influences the filtering control (460). For instance, the general encoding control (420) can be configured to control SAO filtering (e.g., via SAO filter control data (423)) during encoding so that it is performed according to any one or more of the described techniques.

The methods can be used, for example, as part of a process for determining what the value of sample_adaptive_offset_enabled_flag should be for a sequence parameter set; what the values of the slice_sao_luma_flag and the slice_sao_chroma_flag, respectively, should be for a particular slice; how and when the sao_type_idx_luma and sao_type_idx_chroma syntax elements should be specified for a particular CTU; and/or how and when the EO- and BO-specific syntax elements should be specified for a particular CTU.

The disclosed examples should not be construed as limiting, as they can be modified in many ways without departing from the principles of the underlying invention. Also, any of the methods can be used alone or in combination with one or more other SAO control methods disclosed herein. Furthermore, in some instances, any one or more of the disclosed methods are used as at least part of other processes for determining whether to perform SAO filtering and/or whether either EO or BO filtering should be used. For example, any of the disclosed embodiments can be used in combination with any of the embodiments disclosed in PCT International Application No. PCT/CN2014/076446, entitled “Encoder-Side Decisions for Sample Adaptive Offset Filtering” and filed on Apr. 29, 2014.

A. Skipping Evaluation of Selected Edge Offset Filters

In a typical encoder that uses SAO filtering, the encoder will evaluate each of the SAO directional edge offset filters for potential use during encoding (and for signaling for use by the decoder). In particular, the encoder will evaluate each of the 0°, 45°, 90°, and 135° edge offset filters. This evaluation of each filter, however, consumes processing resources and takes valuable encoding time to perform. Further, the processing resources used during the evaluation of each filter is not constant across all filters. To improve encoder speed and reduce the computational burden used to evaluate these directional edge offset filters, and in accordance with certain embodiments of the disclosed technology, the evaluation of the application of one or more of the directional edge offset filters is skipped during encoding.

In particular implementations, one or more of the following criteria are used to determine which one(s) of the directional edge offset filter(s) to skip: (1) the rate at which the filter is selected in practice in comparison to the other edge offset filters; and/or (2) the computational burden involved in evaluating the application of the filter. The rate at which the filter is selected in practice may be based on statistics maintained during the encoding process of a particular video sequence (or set of pictures in the sequence, or picture in the sequence), or be based on statistics observed across a variety of different video sequences, which are then applied heuristically to a particular encoder embodiment. Further, the criteria can be evaluated and applied to the encoder control using a weighted sum or other balanced approach designed to determine which of the filters to skip the evaluation of during encoding while also attempting to reduce the impact on overall encoding quality.

In accordance with certain example embodiments, both the 45° and 135° filters are skipped for consideration during encoding. Thus, for example, the encoder only evaluates the 0° and 90° degree filter during encoding and skips the other two. This embodiment can be used, for example, in encoder implementations in which the 0° and 90° (horizontal and vertical) filter operate more efficiently than the other two filters (the 45° and 135° filters). Other arrangements, however, are also possible, including skipping just one of the 45° or 135° filter (or alternating the skipping of one or more of the filters on a frame-by-frame, block-by-block, CTU-by-CTU, unit-by-unit, or other basis). Still further, where multiple directional filters are available and one is selected for use, filters that are not orthogonal to that selected filter can be skipped (stated differently, orthogonal directional filters can be applied, whereas directional filters that are non-orthogonal to an applied filter can be skipped).

Embodiments of the disclosed edge offset filter skipping techniques have particular application to scenarios in which efficient, fast encoding is desirable, such as real-time encoding situations (e.g., encoding of live events, video conferencing applications, and the like). Thus, the skipping of one or more of the edge offset directional filters can be performed when an encoder is operating in a low-latency and/or fast encoding mode (e.g., for real-time (or substantially real-time) encoding, such as during the encoding of live events or video conferencing). Otherwise, when operating in a normal (or other) mode, the encoder can evaluate all four of the edge offset directional filters.

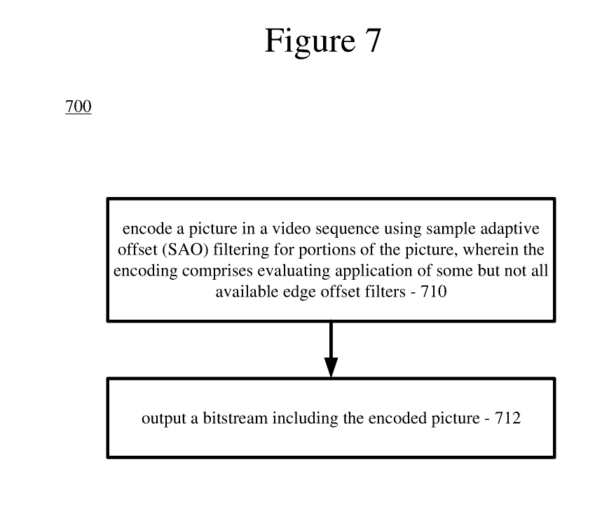

FIG. 7 is a flow chart (700) illustrating an exemplary embodiment for performing SAO filtering (e.g., for controlling SAO filtering by general encoding control (420)) and/or filter control (460)) according to this aspect of the disclosed technology. The disclosed embodiment can be performed by a computing device implementing a video encoder, which may be further configured to produce a bitstream compliant with the H.265/HEVC standard. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At (710), a picture in a video sequence is encoded using sample adaptive offset (SAO) filtering for portions of the picture. In the illustrated embodiment, the encoding of the picture using SAO filtering comprises evaluating application of some but not all available edge offset filters. As one example, the evaluating of the application of some but not all available edge offset filters can comprise skipping the 45-degree and 135-degree edge offset filters specified in the HEVC/H.265 standard. Stated differently, the evaluating of the application of some but not all available edge offset filters comprises evaluating only 0-degree and 90-degree edge offset filters.

At (712), a bitstream including the encoded picture is output. For instance, the bitstream can include one or more syntax elements that control application of SAO filtering during decoding of the picture and include no signals for 45-degree and 135-degree edge offset filters for the picture.

The encoding of the picture using SAO filtering as in FIG. 7 can further comprise evaluating the application of one or more band offset filters in addition to the evaluated edge offset filters. That is, the SAO filtering performed in FIG. 7 can include consideration of both edge offset filtering and band offset filtering, but with a reduced number of edge offset filters being considered as noted above.

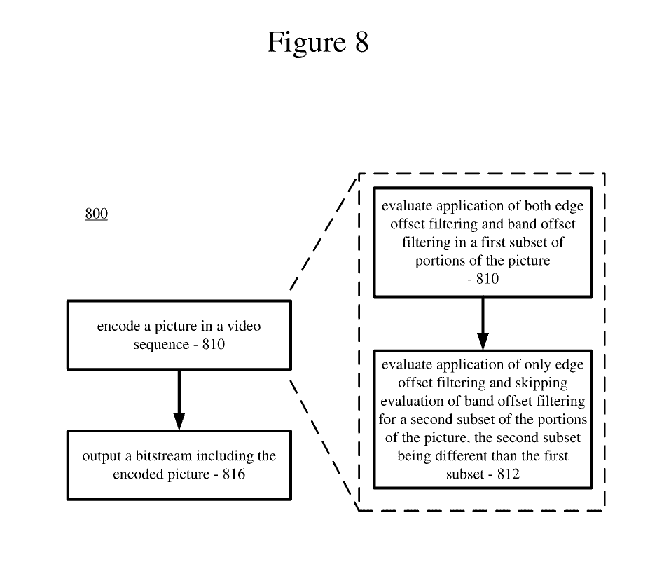

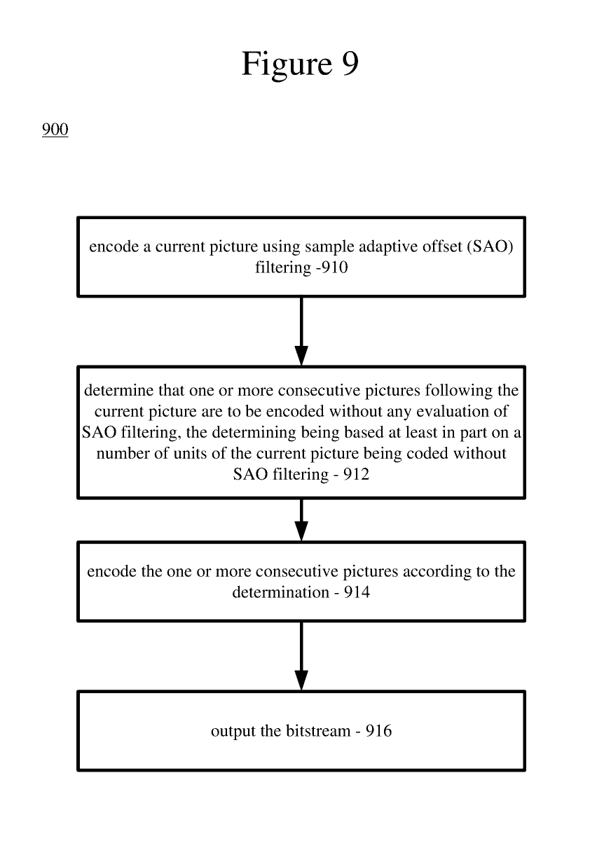

Still further, any of the embodiments disclosed herein (e.g., the embodiments of FIGS. 7, 8, and 9) can be used in combination with one another. For example, the encoding can further comprise skipping evaluation of band-offset filtering for at least some portions of the picture (e.g., skipping band-offset filtering as discussed below with respect to FIG. 8). Or, the encoding can further comprise skipping evaluation of all SAO filtering for at least some portions of the picture (e.g., every other unit (such as a CTU) in a picture). Still further, the encoding can further include a determination by which one or more pictures following the current picture being encoded in sequence have no SAO filtering evaluated or otherwise performed during encoding (e.g., as in FIG. 9 below). For example, the picture of FIG. 7 can be a current picture, and the method can further comprise: determining that one or more consecutive pictures following the current pictures are to be encoded without any evaluation of SAO filtering, the determining being based at least in part on a number of units of the current picture being coded without SAO filtering; and encoding the one or more consecutive pictures according to the determination.

These example embodiments can be performed as part of an encoding operation in which computational efficiency and encoder speed are desirably increased (potentially at the cost of some increased distortion or quality loss). For example, in some instances, the embodiments are performed as part of a real-time or substantially real-time encoding operation. For instance, the embodiments can be implemented as part of a video conferencing system or system configured to encode live events. Still further, these example embodiments can be used when the encoder is configured to operate in a low-latency and/or fast encoding mode.

B. Selectively Skipping SAO Filtering For Picture Portions

In a typical encoder implementing SAO filtering, the encoder will evaluate the possible application of SAO filtering (including both edge offset filtering and band offset filtering) for each picture portion of the picture being currently encoded. This evaluation for the application of SAO filtering consumes computational resources and takes valuable encoder time. To improve encoder speed and reduce the computational burden used to evaluate the application of certain SAO filtering schemes, and in accordance with certain embodiments of the disclosed technology, the evaluation of the application of band offset filtering (or of edge offset filtering) is skipped for at least some of the picture portions of a picture being encoded. Still further, the evaluation of the application of the band offset filter (or of the edge offset filter) can be partially skipped just for luma components, just for chroma components, or for both luma and chroma components.

In particular implementations, one or more of the following criteria are used to determine which of either band offset filtering or edge offset filtering is partially skipped: (1) the rate at which the filtering scheme is selected in practice in comparison to the other SAO schemes; and/or (2) the computational burden involved in evaluating the application of the SAO filtering scheme. The rate at which band offset filtering (and/or edge offset filtering) is selected in practice may be based on statistics maintained during the encoding process of a particular video sequence (or set of pictures in the sequence, or picture in the sequence), or be based on statistics observed across a variety of different video sequences, which then are applied heuristically to a particular encoder embodiment. Further, the criteria can be evaluated and applied to the encoder control using a weighted sum or other balanced approach designed to determine which of the filtering schemes (either band offset or edge offset filtering) to skip while also attempting to reduce the impact on overall encoding quality

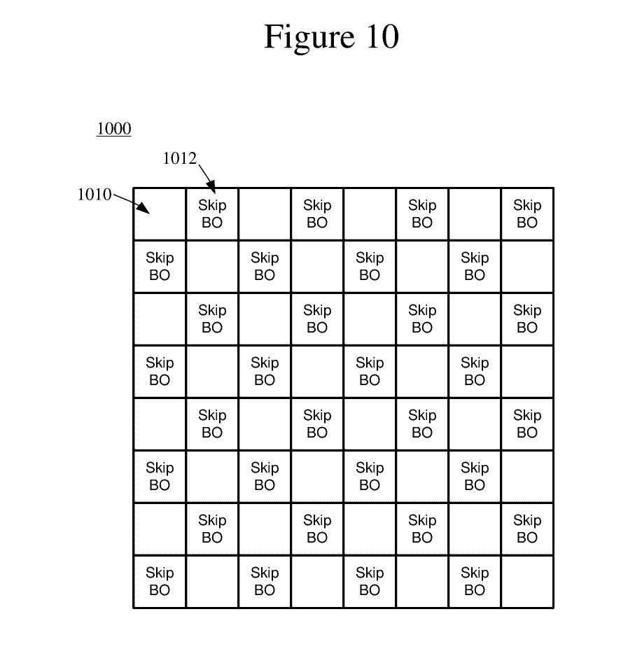

In certain embodiments, the encoder skips the evaluation of band offset filtering for luma components of one or more units of a picture currently being encoded. For instance, in example implementations, the encoder skips the evaluation of band offset filtering for luma components in every other unit of a picture being encoded. In one particular implementation, for instance, the encoder evaluation of band offset filtering is skipped for every other luma CTB. This results in a checkerboard pattern for application of the band offset filter to the luma CTBs, as illustrated by schematic block diagram 1000 in FIG. 10. In block diagram 1000, a first example CTB 1010 is shown in which evaluation of both edge offset filtering and band offset filtering is performed as well as a second example CTB 1012 in which evaluation of only edge offset filtering is performed and in which evaluation of band offset filtering is skipped (denoted as “skip BO”). In this implementation, the processing used to evaluate band offset filtering is not as efficient as with edge offset filters for the luma components. Further, by alternately applying the evaluation of the band offset scheme, there exists an increased likelihood that the unit for which the evaluation is skipped will inherit application of any band offset scheme collected by virtue of being designated a “merge” block (unit) with its neighbor.

It should be understood that the alternating of the evaluation of the band offset filter can be performed for different-sized units as well, as well as for encoders that allow size variation among the available units. Further, in some implementations, the skipping of the band offset filter is only performed for some of the pictures being encoded (e.g., every other picture). Still further, the units for which band offset filter evaluation is skipped are alternated from picture to picture (e.g., the checkerboard pattern of FIG. 10 is inverted for a next consecutive picture being encoded). In still other implementations, the encoder skips evaluation of band offset filtering using other rules or patterns. For example, the encoder can skip evaluation of band offset filtering for a next luma CTB if a current CTB is evaluated for band offset filtering and the filtering is not selected (or if no SAO filtering is selected for the current block).

It should be understood that any of the disclosed schemes referring to the skipping of band offset filtering can adapted to skip edge offset filtering instead, or to skip band offset filtering and edge offset filtering.

Embodiments of the disclosed filter-scheme skipping techniques have particular application to scenarios in which efficient, fast encoding is desirable, such as real-time encoding situations (e.g., encoding of live events, video conferencing applications, and the like). Thus, the selective skipping of evaluation of band offset filtering (or edge offset filtering) can be performed when an encoder is operating in a low-latency and/or fast encoding mode (e.g., for real-time (or substantially real-time) encoding, such as during the encoding of live events or video conferencing). Otherwise, when operating in a normal (or other) mode, the encoder can evaluate the application of both the edge offset filter and the band offset filter.

FIG. 8 is a flow chart (800) illustrating an exemplary embodiment for performing SAO filtering (e.g., for controlling SAO filtering by general encoding control (420)) and/or filter control (460)) according to this aspect of the disclosed technology. In general, FIG. 8 illustrates a method in which a picture in a video sequence is encoded (including the evaluation of one or more of the sample adaptive offset (SAO) filtering schemes for portions of the picture). The disclosed embodiment can be performed by a computing device implementing a video encoder, which may be further configured to produce a bitstream compliant with the H.265/HEVC standard. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At (810), a picture in a video sequence is encoded (e.g., including evaluation of sample adaptive offset (SAO) filtering). The picture is formed from a plurality of picture portions (e.g., CTUs). Further, in the illustrated embodiment, the picture portions include luma picture portions (such as luma coding tree blocks (CTBs)) and chroma picture portions (such as chroma CTBs).

In the illustrated embodiment, at (812), the encoding comprises evaluating application of both an edge offset filter and a band offset filter to a first subset of the picture portions of the picture, and, at (814), evaluating application of only an edge offset filter and skipping evaluation of the band offset filter to a second subset of the picture portions of the picture, the second subset being different than the first subset.

At (816), a bitstream including the encoded picture is output. The bitstream can include, for example, one or more syntax elements that control application of SAO filtering during decoding and that signal skipping of the band-offset filtering for selected units of the encoded picture.

In certain implementations, the first subset of the picture portions of the picture comprises a first subset of luma picture portions (e.g., luma CTBs), and the second subset of the picture portions of the picture comprises a second subset of the luma picture portions (e.g., luma CTBs) for the picture. The second subset of the picture portions of the picture can be, for example, at least partially interleaved between the first subset of the picture portions of the picture. For instance, the interleaved second subset of the picture portions of the picture can form a checkerboard pattern with the first subset of the picture portions of the picture (e.g., as illustrated in FIG. 10). Further, the picture portions of the first subset and the second subset can be luma picture portions for which the band offset filter is alternately evaluated; in such implementations, the band offset filter can continue to be evaluated for the chroma picture portions (e.g., for all chroma CTBs for the picture).

In further implementations, the picture portions of the picture having the skipped evaluation of SAO filtering aspects can alternate from picture to picture. For instance, in one implementation, the picture is a first picture, and the encoding operations further comprise encoding a second picture subsequent and consecutive to the first picture (where the second picture is also formed of picture portions, including luma picture portions (e.g., luma CTBs) and chroma picture portions (e.g., chroma CTBs)). In this implementation, the encoding comprises evaluating application of both an edge offset filter and a band offset filter in a first subset of the picture portions of the second picture, the first subset of the picture portions of the second picture being different than the first subset of the picture portions of the first picture; and evaluating application of only an edge offset filter and skipping evaluation of the band offset filter for a second subset of the picture portions of the second picture, the second subset of the picture portions of the second picture being different than the first subset of the picture portions of the second picture, the second subset of the picture portions of the second picture also being different than the second subset of the picture portions of the first picture. As above, the first subset and the second subset can comprise luma picture portions (e.g., luma CTBs), and the edge offset filter and the band offset filter can continue to be evaluated for the chroma picture portions of the second picture (e.g., for all CTBs of the second picture).

Again, any of the embodiments disclosed herein (e.g., the embodiments of FIGS. 7, 8, and 9) can be used in combination with one another.

These example embodiments can be performed as part of an encoding operation in which computational efficiency and encoder speed are desirably increased (potentially at the cost of some increased distortion or quality loss). For example, in some instances, the embodiments are performed as part of a real-time or substantially real-time encoding operation. For instance, the embodiments can be implemented as part of a video conferencing system or system configured to encode live events. Still further, these example embodiments can be used when the encoder is configured to operate in a low-latency and/or fast encoding mode.
C. Adaptively Skipping SAO Filtering for Subsequent Pictures Based on Content of Current Picture

In other encoder embodiments, the encoder is configured to adaptively enable or disable SAO filtering (e.g., for one or more entire pictures being encoded). In particular embodiments, the selection of when to disable SAO filtering (and for how long) is based at least in part on the content of a current picture being encoded. In particular embodiments, SAO filtering can be disabled for one or more consecutive pictures after a current picture being encoded, and the selection of when to disable SAO filtering and for how long can be based on encoding results from the current picture. For example, the encoding results can monitor the rate at which SAO filtering is applied to units of the current picture. For example, the number of units with no SAO filtering selected by the encoder relative to the total number of units for the picture can be monitored. The encoder can then evaluate this monitored result and adaptively select to disable evaluation of SAO filtering for one or more consecutive pictures after the current picture. This approach is based on an expectation that pictures having low SAO usage during encoding will be followed by additional pictures having low SAO usage, thus creating an opportunity to increase the computational efficiency of the encoder by avoiding the processing and resource overhead associated with evaluating the applications of the SAO filtering schemes. However, by skipping the evaluation of SAO filtering entirely in the consecutive pictures, there is some risk that certain units in the consecutive pictures will display image data in those pictures that would normally be encoded using one of the SAO filters.

In one example embodiment, a so-called “SAO OFF ratio” can be used. The SAO OFF ratio for a given picture can be the number of units encoded without SAO divided by the total number of units in the picture (e.g., the number of units having a sample_adaptive_offset_enabled_flag disabled relative to the total number of units for the picture). In one particular implementation, the SAO OFF ratio for a given picture is the number of coding tree units encoded without SAO in the picture divided by the total number of coding tree units in the picture. This implementation can be particularly useful in situations where the coding tree unit size is constant during encoding of a picture. The SAO OFF ratio can then be used by the encoder to determine whether, and for how many subsequent pictures, the evaluation of the SAO filter can be skipped. For instance, in one particular implementation, the number of subsequent pictures to skip is determined according to the following:

TABLE 2
Example SAO OFF Ratios and Numbers of Pictures
to Disable SAO Evaluation

| SAO | Number of Subsequent |
|---|---|
| OFF | Pictures to Skip SAO |
| Ratio | Evaluation |
| <0.6 | 0 pictures |
| 0.6 to <.75 | 1 picture |
| .75 to <.875 | 2 pictures |
| .857 to 1 | 3 pictures |

The ratios and numbers of pictures shown in Table 2 are by way of example only and should not be construed as limiting. Instead, the ratios and numbers can be adjusted to achieve any desired tradeoff between encoder efficiency and video compression quality.

The application of this adaptive encoding approach can be modified in a variety of manners, all of which are considered to be within the scope of the disclosed technology. For example, if one of the subsequent pictures is determined to be an intra coded picture, then the skipping process can be halted. Still further, during encoding of the current picture, the encoder can be adapted to skip the evaluation of SAO filtering for particular units in certain situations. For instance, if a unit (e.g., a coding tree unit) is determined to be a “skip mode” unit (e.g., a “skip mode” CTU), then the evaluation of the SAO filtering for that unit can be disabled.

Embodiments of the disclosed adaptive SAO skipping techniques have particular application to scenarios in which efficient, fast encoding is desirable, such as real-time encoding situations (e.g., encoding of live events, video conferencing applications, and the like). Thus, embodiment of the disclosed adaptive SAO skipping techniques can be performed when an encoder is operating in a fast encoding mode (e.g., for real-time (or substantially real-time) encoding, such as during the encoding of live events or video conferencing). Otherwise, when operating in a normal (or other) mode, the encoder can evaluate SAO filtering normally without any picture-wide skipping as in embodiments of the disclosed technology.

FIG. 9 is a flow chart (900) illustrating an exemplary embodiment for performing SAO filtering (e.g., for controlling SAO filtering by general encoding control (420)) and/or filter control (460)) according to this aspect of the disclosed technology. The disclosed embodiment can be performed by a computing device implementing a video encoder, which may be further configured to produce a bitstream compliant with the H.265/HEVC standard. The particular embodiment should not be construed as limiting, as the disclosed method acts can be performed alone, in different orders, or at least partially simultaneously with one another. Further, any of the disclosed methods or method acts can be performed with any other methods or method acts disclosed herein.

At (910), a current picture is encoded using sample adaptive offset (SAO) filtering.

At (912), a determination is made that one or more consecutive pictures following the current picture are to be encoded without any evaluation of SAO filtering. In particular embodiments, the determination is based at least in part on a number of units of the current picture being coded without SAO filtering. For example, the determination can be made by determining an SAO ratio for the current picture, the SAO ratio comprising a ratio relating a number of CTUs being flagged as not having SAO filtering to a total number of CTUs in the current picture, and determining from the SAO ratio the number of the consecutive pictures following the current picture for which evaluation of SAO filtering is to be skipped. The number of pictures to skip can vary depending on the SAO ratio. For instance, the number of pictures to skip evaluation of SAO filtering can increase as the SAO ratio increases. In one particular implementation, the skipping is performed in accordance with Table 2 above. In certain embodiments, the unit (used in determining the number of units of the current picture being coded without SAO filtering) is a coding tree unit or CTU.

At (914), the one or more consecutive pictures are encoded according to the determination.

At (916), a bitstream is output with the encoded current picture and the one or more consecutive pictures. The bitstream can include, for example, one or more syntax elements that control application of SAO filtering during decoding and that signal skipping of SAO filtering for the one or more consecutive pictures following the current pictures in accordance with the determination.

Again, any of the embodiments disclosed herein (e.g., the embodiments of FIGS. 7, 8, and 9) can be used in combination with one another.

These example embodiments can be performed as part of an encoding operation in which computational efficiency and encoder speed are desirably increased (potentially at the cost of some increased distortion or quality loss). For example, in some instances, the embodiments are performed as part of a real-time or substantially real-time encoding operation. For instance, the embodiments can be implemented as part of a video conferencing system.

### VII. Concluding Remarks

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims and their equivalents.

We claim:

1. A video encoder system, comprising:
a buffer configured to store pictures of a video sequence to be encoded; and a video encoder configured to encode the pictures of the video sequence by:
encoding a current picture using sample adaptive offset (SAO) filtering;
determining that one or more consecutive pictures following the current picture are to be encoded without any evaluation of SAO filtering, the determining being based at least in part on a number of units of the current picture being coded without SAO filtering; and
encoding the one or more consecutive pictures according to the determination.

2. The video encoder system of claim 1, wherein the video encoder is configured to perform the determining by:
determining an SAO ratio for the current picture, the SAO ratio comprising a ratio relating a number of coding tree units (CTUs) being flagged as not having SAO filtering to a total number of CTUs in the current picture; and
determining a number of the consecutive pictures following the current picture for which evaluation of SAO filtering is to be skipped from the SAO ratio.

3. The video encoder system of claim 2, wherein the number is variable and increases as the SAO ratio increases.

4. The video encoder system of claim 1, wherein the unit is a coding tree unit.

5. The video encoder system of claim 1, wherein the video encoder system performs the encoding in real-time or substantially real-time.

6. The video encoder system of claim 1, wherein the video encoder system is part of a video conferencing system.

7. The video encoder system of claim 1, wherein the video encoder is further configured to encode the pictures of the video sequence by:
outputting a bitstream with the encoded current picture and the one or more consecutive pictures, the bitstream further including one or more syntax elements that control application of SAO filtering during decoding and signal skipping of SAO filtering for the one or more consecutive pictures following the current pictures in accordance with the determination.

8. One or more computer-readable memory or storage devices storing computer-executable instructions which when executed by a computing device causes the computing device to perform encoding operations comprising:
encoding a picture in a video sequence, the picture being formed from picture portions, the picture portions including luma picture portions and chroma picture portions, the encoding of the picture comprising:
evaluating application of both edge offset filtering and band offset filtering to a first subset of the picture portions;
evaluating application of only edge offset filtering and skipping evaluation of band offset filtering for a second subset of the picture portions, the second subset being different than the first subset; and
outputting a bitstream including the encoded picture.

9. The one or more computer-readable memory or storage devices of claim 8, wherein the luma picture portions comprise luma coding tree blocks, wherein the first subset of the picture portions comprises a first subset of the luma coding tree blocks, and wherein the second subset of the portions of the picture comprises a second subset of the luma coding tree blocks.

10. The one or more computer-readable memory or storage devices of claim 9, wherein the encoding of the picture further comprises evaluating application of both edge offset filtering and band offset filtering for the chroma picture portions of the picture.

11. The one or more computer-readable memory or storage devices of claim 8, wherein the second subset of the picture portions is at least partially interleaved between the first subset of the picture portions.

12. The one or more computer-readable memory or storage devices of claim 8, wherein the second subset of the picture portions forms a checkerboard pattern with the first subset of the picture portions.

13. The one or more computer-readable memory or storage devices of claim 8, wherein the picture is a first picture, and wherein the encoding operations further comprise:
encoding a second picture subsequent and consecutive to the first picture, the encoding comprising:
evaluating application of both edge offset filtering and band offset filtering to a first subset of picture portions of the second picture, the first subset of the picture portions of the second picture being different than the first subset of the picture portions of the first picture; and
evaluating application of only edge offset filtering and skipping evaluation of band offset filtering for a second subset of the picture portions of the second picture, the second subset of the picture portions of the second picture being different than the first subset of the picture portions of the second picture, the second subset of the picture portions of the second picture also being different than the second subset of the picture portions of the first picture.

14. A method comprising:
by a computing device implementing a video encoder:
encoding a picture in a video sequence using sample adaptive offset (SAO) filtering for portions of the picture, wherein the encoding of the picture using SAO filtering comprises evaluating application of some but not all available edge offset filters; and
outputting a bitstream including the encoded picture.

15. The method of claim 14, wherein the evaluating application of some but not all available edge offset filters comprises skipping 45-degree and 135-degree edge offset filters.

16. The method of claim 14, wherein the evaluating application of some but not all available edge offset filters comprises evaluating only 0-degree and 90-degree edge offset filters.

17. The method of claim 14, wherein the evaluating application of some but not all available edge offset filters comprises skipping non-orthogonal edge offset filters.

18. The method of claim 14, wherein the encoding of the picture using SAO filtering further comprises evaluating application of one or more band offset filters in addition to the evaluated edge offset filters.

19. The method of claim 14, wherein the encoding further comprises skipping evaluation of SAO filtering for at least some portions of the picture.

20. The method of claim 14, wherein the picture is a current picture, and wherein the method further comprises:
determining that one or more consecutive pictures following the current pictures are to be encoded without any evaluation of SAO filtering, the determining being based at least in part on a number of units of the current picture being coded without SAO filtering; and
encoding the one or more consecutive pictures according to the determination.
